(19) United States
(12) Patent Application Publication
(10) Pub. No.: US 2009/0194959 A1
(43) Pub. Date: Aug. 6, 2009

(54) MOBILE PLATFORM METHODS AND SYSTEM

(75) Inventors: James Mintie, Los Angeles, CA (US); Jose Munoz, Los Angeles, CA (US)

Correspondence Address: FOLEY & LARDNER, 555 South Flower Street, SUITE 3500, LOS ANGELES, CA, 90071-2411, US

(73) Assignee: MINTIE TECHNOLOGIES, INC.

(21) Appl. No.: 12/362,402

(22) Filed: Jan. 29, 2009

Related U.S. Application Data
(60) Provisional application No. 61/025,716, filed on Feb. 1, 2008.
(60) Provisional application No. 61/063,663, filed on Feb. 4, 2008.

(51) Int. Cl. B62B 3/02; B62B 1/10

(52) U.S. Cl. 280/47.131; 280/29

(57) ABSTRACT

A base for supporting the weight of a user, tools and a ladder is described. The base can be formed of a plurality of rigid plates, each plate having a top and a bottom side. The plates can be hingedly connected to fold together along a longitudinal axis with the bottom sides of the respective plates being positioned adjacent to each other. The base can include a plurality of wheels positioned around the bottom side and the periphery of each plate. The wheels can be positioned to oppose one another and the opposed wheels being positioned off center from each other when the plates are folded such that the wheels do not interfere with each other, the base when folded is adapted to be stored with the longitudinal axis in a substantially vertical direction.

### CROSS-REFERENCE TO RELATED PATENT APPLICATIONS

Embodiments of the present invention relate to U.S. Provisional Application No. 61/025,716, filed Feb. 1, 2008, entitled ECU Mobile Platform, which is incorporated herein by reference in its entirety and from which the priority filing date is claimed.

Embodiments of the present invention relate to U.S. Provisional Application No. 61/063,663, filed Feb. 4, 2008, entitled ECU Mobile Platform, which is incorporated herein by reference in its entirety and from which the priority filing date is claimed.

### FIELD AND BACKGROUND

Various types of job sites can use mobile platforms that support the weight of a user that utilizes various tools. The job sites can include but are not limited to, construction, medical, pharmaceutical, biotechnological, clean rooms, semiconductor or other industrial sites that can use particulate control or containment units. Workers at a construction site often relocate from one location to another location on a work site. The relocation of a worker can also require the relocation of various tools and the ladder the worker may be using.

The embodiments of the present invention relate generally to the field of mobile platforms that can be used to support the weight of workers and tools, and allowing the worker to move the platform from one location to another location. In particular, the embodiments of the present invention include platforms that can be folded to be transformed into a dolly for ease of mobility.

### SUMMARY OF THE DISCLOSURE

Embodiments of the present invention can include a base for supporting weight. The base can be formed of a plurality of rigid plates, each plate having a top and a bottom side. The plates can be hingedly connected to fold together along a longitudinal axis with the bottom sides of the respective plates being positioned adjacent to each other. The base can include a plurality of wheels positioned around the bottom side and the periphery of each plate. The wheels can be positioned to oppose one another and the opposed wheels being positioned off center from each other when the plates are folded such that the wheels do not interfere with each other, the base when folded is adapted to be stored with the longitudinal axis in a substantially vertical direction.

Another embodiment of the present invention can include an L-shaped plate having at least one wheel and adapted to be at least temporarily attached to one end of the folded plates to enable the folded plates to be transported by rolling the at least one wheel and the base supported by the L-shaped plate.

Yet another embodiment of the present invention can include a base for supporting weight. The base having a plurality of rigid plates, each plate having top and bottom sides, the plates being hingedly connected to fold together along a longitudinal axis. The base having a means for folding the plates together in one direction so that the bottoms of the plates are adjacent to each other when the plates are folded together. The base can include a plurality of wheels positioned around the bottom periphery of the plates, the wheels being positioned off center with respect to each other so that they do not interfere with each other when the plates are folded together. The wheels can support the bottom of the plates flush or close to flush against the floor, in order to provide a low center of gravity for the base when the plates are in an unfolded orientation. In one embodiment the wheels can support the bottom of the plate about 2 to 6 inches (including but not limited to, about 3, 4 and 5 inches) above the floor in order to provide a low center of gravity for the base when the plates are in an unfolded orientation.

### BRIEF DESCRIPTION OF THE DRAWINGS

FIG. 1 is a top view of a platform according to an embodiment of the present invention.

FIG. 2 is a top view of the partially folded platform according to the embodiment of the present invention shown in FIG. 1.

FIG. 3 is a view of the partially folded mobile platform showing the spacers and the hinges connected the two halves of the platform shown in FIG. 2.

FIG. 4 is a side view of the folded platform according to the embodiment of the present invention shown in FIGS. 1 and 2.

FIG. 5 is a side view of the folded platform showing a retractable handle attached to one end of the platform shown in FIG. 4.

FIG. 6 is a deployed platform showing one of a lockable casters according to an embodiment of the present invention.

FIG. 7 is a bottom view of the mobile platform showing the dolly attachment coupled to the bottom side of the platform according to an embodiment of the present invention.

FIG. 8 is a top view of the L-shaped dolly attachment according to an embodiment of the present invention.

FIG. 9 is a side view of a folded mobile platform and the L-shaped dolly attachment partially sliding onto one end of the mobile platform shown in FIGS. 4 and 5.

FIG. 10 is a perspective view of a person moving the mobile platform and the dolly attachment using wheels of the dolly attachment according to an embodiment of the present invention.

FIG. 11 is a perspective view of the support structure of a containment unit being coupled to the upper surface of the platform as shown in FIGS. 1 and 6; and

FIG. 12 is a side view of the platform with a containment unit erected on top of the mobile platform according to the embodiment of the present invention as shown in FIG. 11.

### DETAILED DESCRIPTION

The embodiments of the present invention relate generally to the field of mobile platforms that can be used to support the weight of one or more user and tools, and allowing the worker to move the platform with ease, while the platform is in a folded or deployed orientation. The platform can be mobile in a folded orientation by collapsing and configured to convert into a dolly. The ease of movement of the platform can lead to increased efficiency and safety around a work site. The mobility of the platform increases the usability of the platform by allowing one user to move the platform quickly without significant effort or injury. These and other features of the platform can allow a user to perform various tasks faster and easier, thereby increasing the productivity of each user. In particular, the embodiments of the present invention include platforms can be folded and wheeled and support a user, tools, ladder and a containment unit or the like.

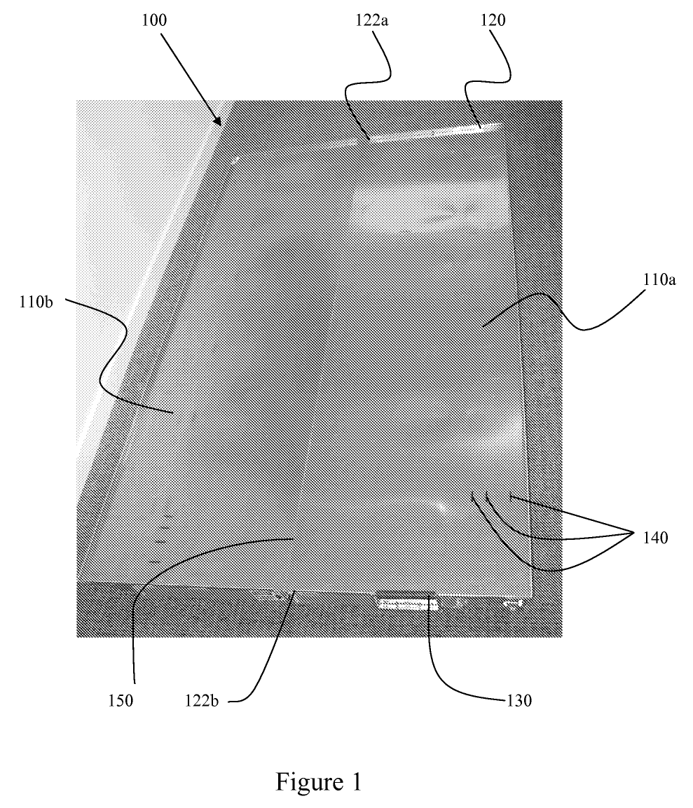

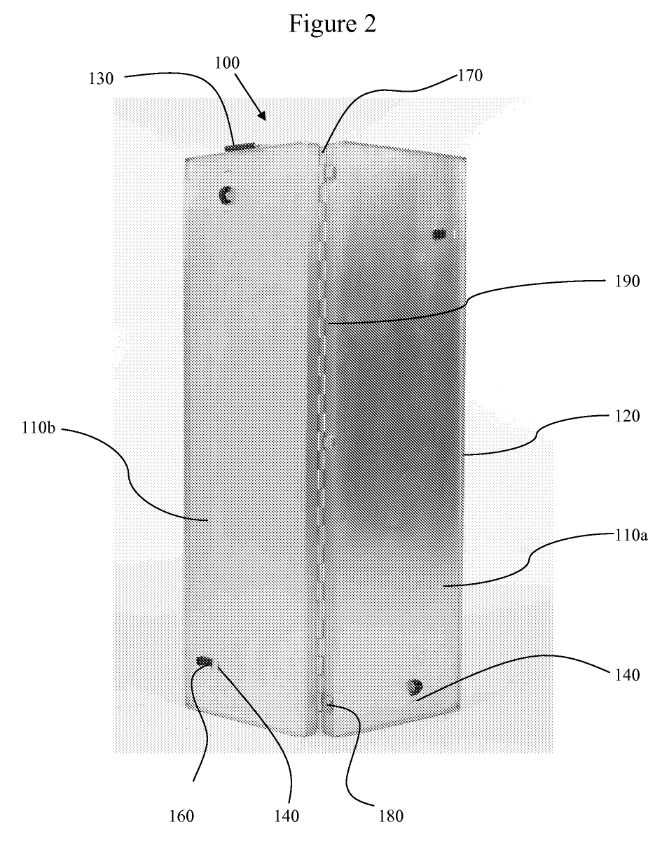

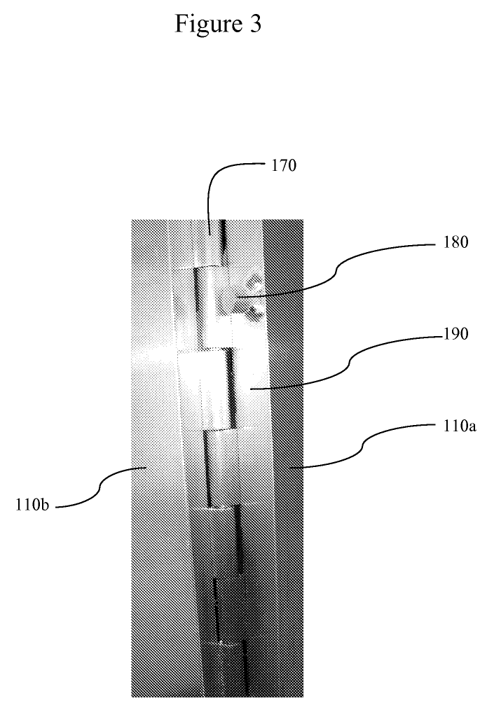

FIG. 1 illustrates a generalized representation of a platform 100 according to an embodiment of the present invention. The platform 100 as shown in FIG. 1 is in a deployed orientation. In other embodiments, the mobile platform 100 can be in a folded orientation, where a plurality of rigid plates that form the platform 100 can be folded at a joint and placed adjacent to one another. While in the deployed orientation, the platform 100 can be a generally planar horizontal surface with a low center of gravity for supporting a user's weight and various tools, such as ladder, hammers, drills, saws, machinery, or the like. The platform 100 may be formed using a plurality of plates 110a and 110b, to further increase the usable surface area for the user. Each plate 110a and 110b can include a top and a bottom surface. In one embodiment, the plates 110a and 110b may be rigid and formed using various metallic alloys, such as but not limited to, aluminum, steel or the like. The low center of gravity of the platform 100 can allow, a user to stand on the top surface of the plates 110a an 110b, while working and using various tools. The platform 100 can allow a user to place a ladder on the top surface of the plates 110a and 110b. Embodiments of the platform 100 can provide stability and a low center of gravity for a user to climb on the ladder and perform maintenance at least on the ceiling or above the ceiling. The low center of gravity of the platform 100 can lead to greater stability when the weight distribution of the load on top the platform 100 is not equally distributed. The stability of the platform 100 also provides safety for the user. The plates 110a and 110b can be positioned adjacent to each other, to form a larger generally planar surface. In one embodiment, the plates 110a and 110b can be in contact with one another. In alternative embodiments there can be a small space between the plates 110a and 110b, while the platform 100 is in a deployed orientation. The plates 110a and 110b can be folded along the longitudinal axis 150 using a joint 170, discussed in greater detail below with regard to FIGS. 2 and 3.

The plates 110a and 110b may have a lip 120 extending upward from at least portions of the outer circumference of each plate 110a and 110b. The lip 120 can be made of the same material the plates 110a and 110b are made of, such as but not limited to, metallic alloys, aluminum, steel or the like. In one embodiment, the lip 120 may be attached to plates 110a and 110b by welding, molding, bending or the like. In an alternative embodiment, the lip 120 and each plate 110a and 110b may be formed of one unitary body. In one embodiment the lip 120 may be in contact with the lip 120 of the other plate. In an alternative embodiment, the lip 120 of each plate 110a and 110b may abut the lip of the other plate as shown in FIG. 1, edges 122a and 122b of lip 120 are a short distance apart from one another. The lip 120 provides a barrier for items that are on the platform 100 and can prevent items from sliding off the platform 100. The lip 120 can prevent items from being inadvertently being pushed off the platform 100. When the platform 100 is being used with a containment unit the lip 120 can provide support for the containment unit and aid in maintaining containment. As will be discussed later edges 122a, 122b and lip 120 can be slideably attached to a dolly attachment to allow the platform 100 to be transformed into a dolly.

In an embodiment of the present invention, a handle 130 can be attached to at least one end of a plate 110a, 110b or a lip 120 attached to the plates. The handle 130 can be attached using any suitable mechanism such as, welding, screws, rivets, or the like. In other embodiments, the handle 130 and the platform 100 can be formed of a single unitary body. The end of the plates 110a or 110b that the handle 130 is attached to can be located at one of the longitudinal end of the plates 110a and 110b. The handle 130 can have a rubber grip and be retractable by using a spring loaded mechanism. The retractable nature of the handle 130 helps avoid creating a trip hazard at a worksite. The handle 130 can be used to wheel or maintain the angular orientation of the platform 100 when being used as a dolly. The angular orientation of the platform 100 allows the user to not have to bear the weight of the platform 100 or other objects that may be placed on the platform 100, making it easier and safer for the user. By using the handle 130 the user can prevent the platform 100 from tipping and allow the unit be to transported with ease and without injury, thereby increasing the both safety and efficiency of the user.

A plurality of elongated perforations 140 can be formed on the plates 110a and 110b and can be used to couple an attachment mechanism to the plates 110a and 110b. The perforations 140 can be elongated and narrowed to not allow items that are on the platform to fall to the ground. The attachment mechanism can include, but are not limited to, Velcro straps, plastic ties, ropes or the like. The perforations 140 may be parallel to one another to allow the attachment mechanism to pass through one perforation to another perforation. In other embodiments, the attachment mechanism may be coupled to a containment unit to allow the containment unit to be securely attached to the plates 110a and 110b and the platform 100. The straps used to secure the items on the platform 100 to the plates 110a and 110b create safety for a user working on the platform 100.

The platform 100 can be configured to fold along its longitudinal axis 150. Folding along the longitudinal axis 150 allows the platform 100 to have a smaller footprint for storage and for transport, as will be discussed in greater detail below. The folded orientation of the platform 100 may occur by having a joint 170 connect the plates 110a and 110b as shown in FIG. 2. The smaller footprint of the platform 100 while the platform 100 is in a folded orientation allows the platform 100 to be easily placed in a small amount of space compared to the amount of surface area the platform 100 can provide while in a deployed orientation.

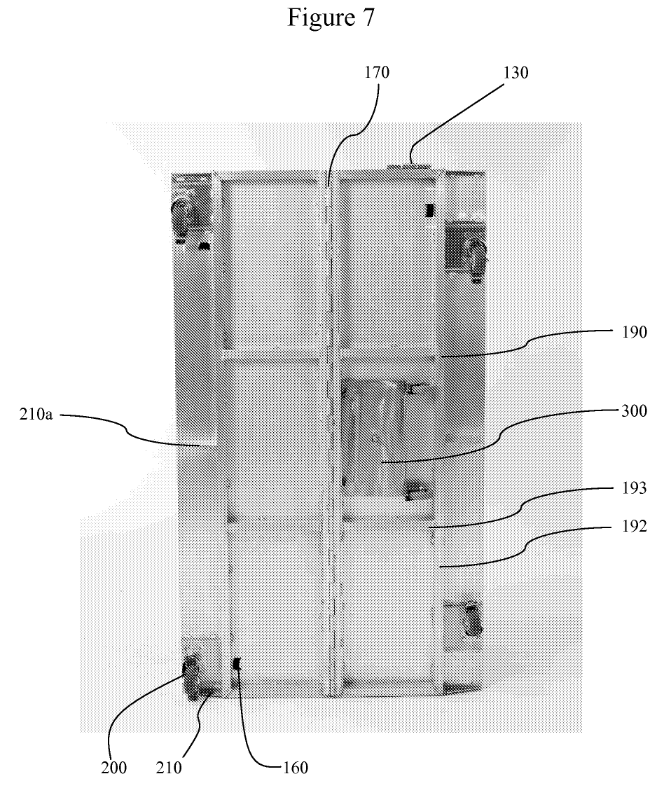

FIG. 2 is a top view of the partially folded mobile platform according to the embodiment of the present invention shown in FIG. 1. The platform 100 may be folded along its longitudinal axis 150 using a joint 170. The joint 170 may be attached to a frame 190 that may be secured to the bottom side of the plates 110a and 110b. The frame 190 (FIGS. 3 and 7) may be formed using the same material used for the plates 110a and 110b. In alternative embodiments, the frame 190 may be formed using different metals or metal alloys, than the plates 110a and 110b. The material of the frame 190 can be molded to form a rectangular, square, triangular, other regular or other irregular shaped beams. The beams can intersect with one another, to form square or rectangular shapes on the bottom of the plates 110a and 110b. The frame 190 can be formed using cross beams and gussets that provide support for each plate 110a and 110b and aid in supporting the weight of the user, tools, ladder and the like. The frame 190 prevents bucking in the platform, even when weight is unevenly distributed because a user is standing on a ladder or the user is standing on one side of the platform 100. The prevention of bucking makes a user feel more secure and thus able to work worry free. Moreover, bucking multiple times during use can damage the items that are on the platform or even degrade the structural integrity of the platform, thus preventing bucking by the use of the frame 190 creates safety and efficiency. The joint 170 may be attached to one side of each frame 190 and thereby creating a joint between the plates 110a and 110b.

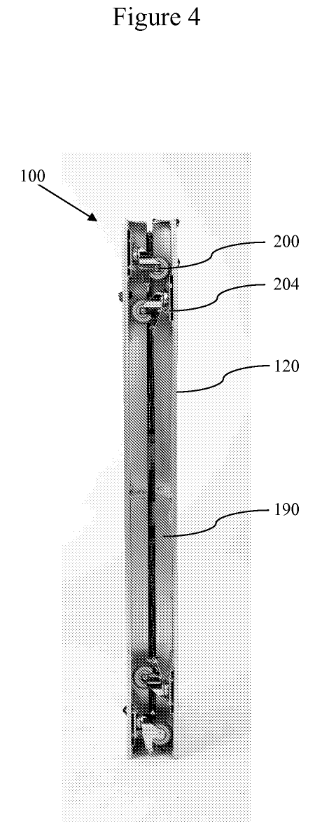

In one example embodiment, the joint 170 can be formed using hinges, such as but not limited to, piano, continuous or butler tray hinges. In one embodiment, a continuous hinge can be formed of two leaves formed of rigid material and a pin connecting the leaves, the pin can resist or limit the movement of the leaves as the leaves rotate into an open position. The rigid material of the leaves of the hinge can be similar to the material of the plates such as metal alloys, like steel, iron or the like. In alternative embodiments, the joint 170 can be formed using other linkages, such as but not limited to, mechanical, chemical, sliding, magnetic or the like. The joint 170 may be formed using various metallic alloys, such as but not limited to, aluminum, steel or the like. Joint 170 can be configured to bear the weight of all the objects that are placed on the platform 100. The joint 170 can be located under the plates 110a and 110b, and open outward to form the platform 100 using the plates 110a and 110b. The joint 170 can be a hinge located the below the surface of the plates 110a and 110b. The joint 170 allows the plates 110a and 110b to fold together in one direction so that the bottom side of each plate 110a and 110b can come closer together. As shown in FIG. 4, the joint 170 can allow the bottom side of each plate 110a and 110b to be folded to be adjacent to each other. The rotational angle of the joint 170 can be from about 0 degrees to about 180 degrees. The rotational angle of the joint 170 also determines the various angles the plates 110a and 110b can be compared to one another, since the joint 170 is indirectly attached to the plates 110a and 110b.

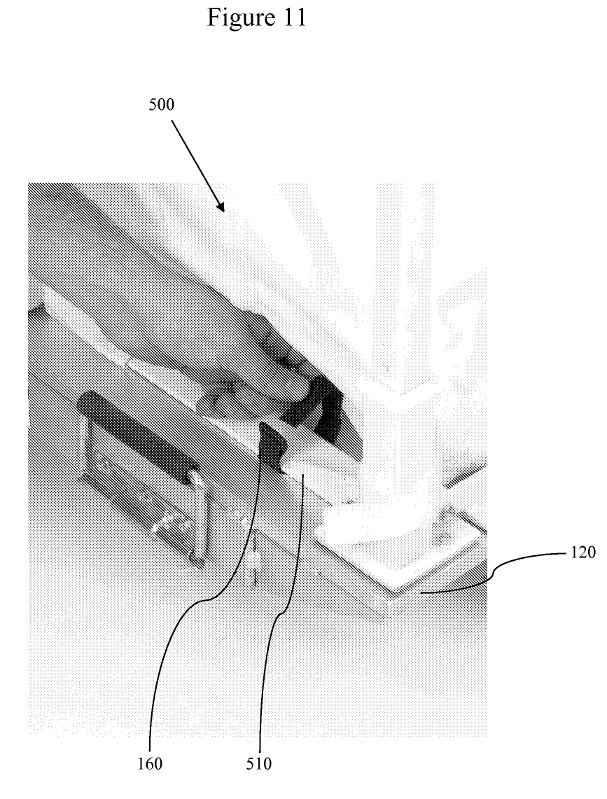

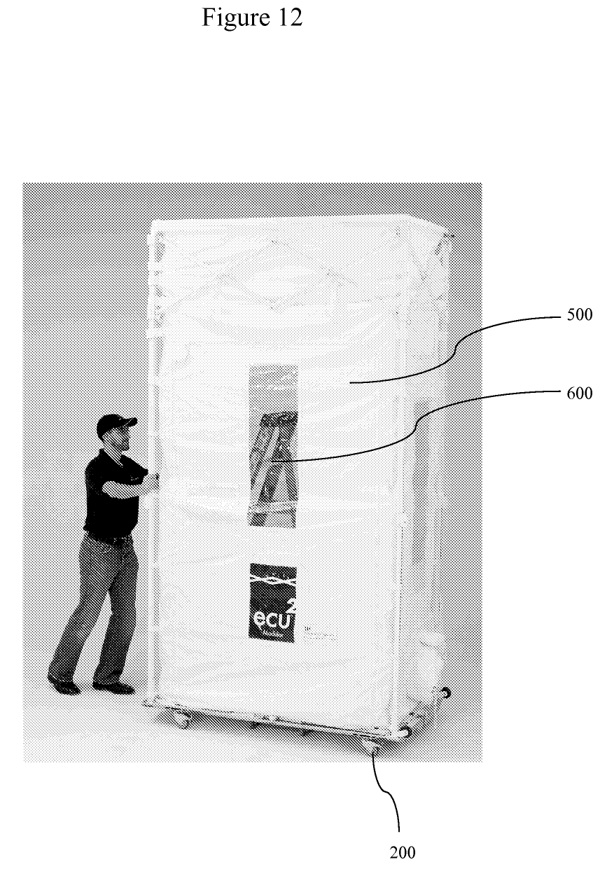

Next, attached to the frames 190 can be spacers 180 (FIG. 3) that further help maintain the structural integrity of the platform 100 while the platform 100 is in a deployed orientation. The spacers 180 may be formed using various solid metallic alloys, such as but not limited to, aluminum, steel, iron or the like. The spacers 180 can be in various shapes such as circular, rectangular, square and the like. The spacers 180 can be attached to the frame 190 under one of the plates 110a or 110b. While the platform 100 is in a deployed orientation, the spacer 180 from one plate can come in contact with or may apply pressure to the frame 190 of the other plate. One function of the spacers 180 can ensure that the joint is well supported and the platform 100 cannot bend against the joint. The spacers 180 are placed on multiple locations adjacent to the joint 170 on the frame 190 to put pressure against the opposing frame 190. By using the spacers 180 the weight of the objects on top the platform 100 can be distributed to the frame and to the wheels. (See. FIGS. 11 and 12).

Also shown in FIG. 2, a plurality of Velcro straps 160 can be attached to plates 110a and 110b by using the elongated perforations 140. The Velcro straps 160 can be attached to various objects that need to be temporarily securely attached to the platform 100. In other embodiments, the Velcro straps 160 may be coupled to a containment unit or other objects to allow the containment unit or other objects to be securely attached to the platform 100. The straps used to secure the items on the platform 100 to the plates 110a and 110b create safety for a user working on the platform 100 and allows the user to work efficiently without having to worry about moving the secured item.

FIG. 3 is a close view of the partially folded mobile platform showing the spacers 180 and the hinges connected the two halves of the mobile platform shown in FIG. 2. The joint 170 is shown with interlinking hinges. The joint 170 can be attached to the frame 190. Also attached to the interior of the frame 190 can be a cylindrical shaped spacer 180. In one embodiment, the spacer 180 can be welded to the interior edge of the frame 190. In an alternative embodiment, the spacer 180 and the frame 190 can be formed as one unitary body. The frame 190 may be attached to the bottom surface of the plates 110a and 110b.

FIG. 4 is a side view of the collapsed folded platform 100, according to the embodiments of the present invention shown in FIGS. 1, 2 and 3. FIG. 4 shows the platform 100 folded along its longitudinal axis with the bottom of the folded platform 100 on the ground. In this configuration, the platform 100 creates a small footprint for ease of storage. In order to create the small footprint for storage, the plurality of casters 200 in this embodiment, are offset from the opposing casters to allow the platform 100 to collapse to create a thin profile. The offset casters 200 allow the platform 100 when in a folded orientation to avoid interference from the opposing casters. The offset positioning of the casters 200 allows the platform to stabilize on at least three contact points with the ground. In the embodiments shown FIG. 4, the platform 100 uses four casters, however, the number of casters can be increased or decreased in alternative embodiments.

The casters 200 are attached to the bottom side of the plates 110a and 110b using an attachment mechanism 204. The attachment mechanism 204 can be a thin U shaped plate. The casters 200 may be attached to the attachment mechanism using screws or other suitable attachment mechanisms. In an alternative embodiment, the casters 200 may be attached using rivets, welding joint, or other suitable mechanical linkages. The attachment mechanism 204 may be attached to the bottom of the plates 110a and 110b using welding, rivets or the like. The casters 200 can be full swivel (rotatable from about 0 up to about 360 degrees) lockable wheels that provide a push lock and unlock mechanism. The wheels in the casters 200 can be formed using a variety of materials, such as but not limited to, plastics, polymers, polyurethane or the like. While in the folded orientation the wheels in the casters 200 are generally not intended to contact the ground. Once folded the platform is intended to be moved using a dolly attachment, discussed in greater detail below. Also shown in FIG. 4 is the exterior edge of the frame 190, with the casters 200 generally located adjacent to the outside of the frame 190. In alternative embodiments, at least one caster 200 can be located within the perimeter of the frame to provide further support and stabilize the platform 100.

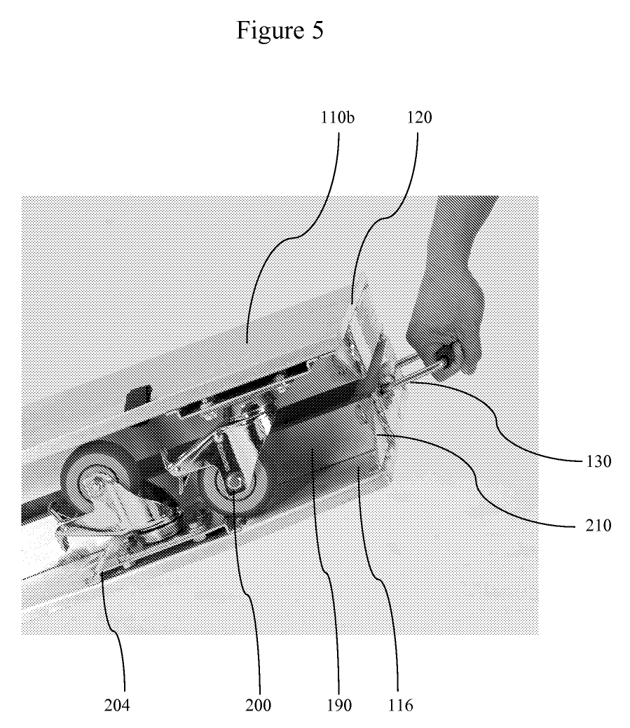

FIG. 5 is a side view of the folded platform showing a retractable handle attached to one or more ends of the platform 100 shown in FIG. 4. A close up view of the side of the folded platform 100 is shown. In particular, the attachment mechanism 204 and caster 200 is shown. In this embodiment, the bottom sides of plates 110a and 110b are shown having moved closer to one another and can be placed adjacent to one another in the folded orientation.

As shown in FIG. 5, a support structure 210 can be welded or attached using other suitable mechanisms to the bottom side of the plate 110b and the frame 190. The support structure 210 can be formed to be in a rectangular, square, triangular, other regular or other irregular shapes and be attached to brace the plates and the frame attached to the bottom of the plates. The support structure 210 may also be attached to the platform 100 using suitable linkages or in alternative embodiments the plate 110b and the support structure may be formed of a single unitary body. Similar support structures can be attached to the other plate 110a.

FIG. 5 shows the handle 130 with a rubber grip and a person extending the handle 130 to be perpendicular to the resting position for the handle 130. The handle 130 can be attached to one end of the platform 100. Various attachment mechanism can be used to attach the handle such as, welding, screws, rivets or the like. The handle 130 can extend outward from the edge of the platform 100 to up to 6 inches to allow a user to keep their hands away from the platform 100 when using the platform 100 as a wheeled dolly.

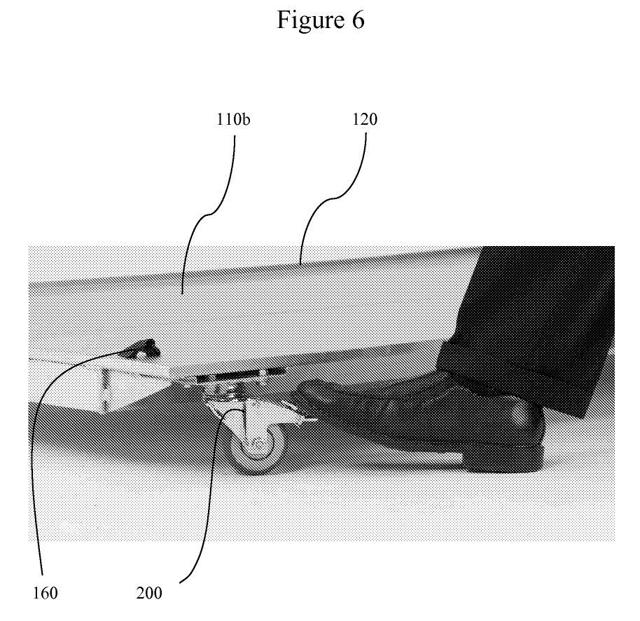

FIG. 6 is a close up view of a deployed platform 100 showing one of a lockable casters 200, according to an embodiment of the present invention. The caster 200 can be locked in position to prevent the movement of the platform when someone is working on the platform by pushing down the locking mechanism. The lockable caster 200 allows a user to stand and move around on the platform 100 without the platform 100 moving, thereby increasing the safety.

The platform 100 as shown in FIGS. 1, 3 and 5 can be designed to provide a low center of gravity by reducing the distance between the ground and plates 110a and 110b. According to another example embodiment, the platform surface can be maintained between about at least 2 inches to about 7 inches (3 inches, 4 inches, 5 inches or 6 inches are acceptable alternatives) away from the floor. In an alternative embodiment, the distance between the ground and the plates 110a and 110b can be about 5 inches or less. The wheels can support the bottom of the plates flush or close to flush against the floor, in order to provide a low center of gravity for the base when the plates are in an unfolded orientation. Having a low center of gravity allows the platform 100 to be more stable than a platform with a higher center of gravity. The reduction in the distance between the ground and the plates 110a and 110b is accomplished by using a thin U shaped attachment mechanisms with low profile casters 200.

In another embodiment, FIG. 7 is a bottom view of the platform 100 showing the dolly attachment 300 coupled to the bottom side of the platform 100. FIG. 7 shows the frame 190 that includes the two generally symmetrical rectangular sets of crossbeams 193 and gussets 192. The crossbeams 193 and gussets 192 inhibit both yaw and buckling of the plates 110a and 110b when the weight of a user, ladder or tools is placed upon the plates 110a and 110b. In one example embodiment, the frame 190 can be the length of the platform 100 and cover most of the width of the platform 100. The width of the frame can be limited by the space needed for casters 200. However, support members 210 and 210a can be used to provide further support to the edges of the platform 100. In an example embodiment, the support members 210 and 210a can be coupled to the plates 110a and 110b by a welding or the like. The support members 210 and 210a can be rigid plates formed of a similar material as the plates 110a and 110b. The support member 210 and 210a can be attached to the plates 110a and 110b with the surface of the support member 210 and 210a being generally perpendicular to the plates 110a and 110b.

The embodiment shown in FIG. 7 includes the joint 170, where the joint 170 is formed using a continuous hinge that is attached to the interior side of the frame 190. Also shown in FIG. 7 is the handle 130 shown folded and not protruding outward, so as to not form a trip hazard.

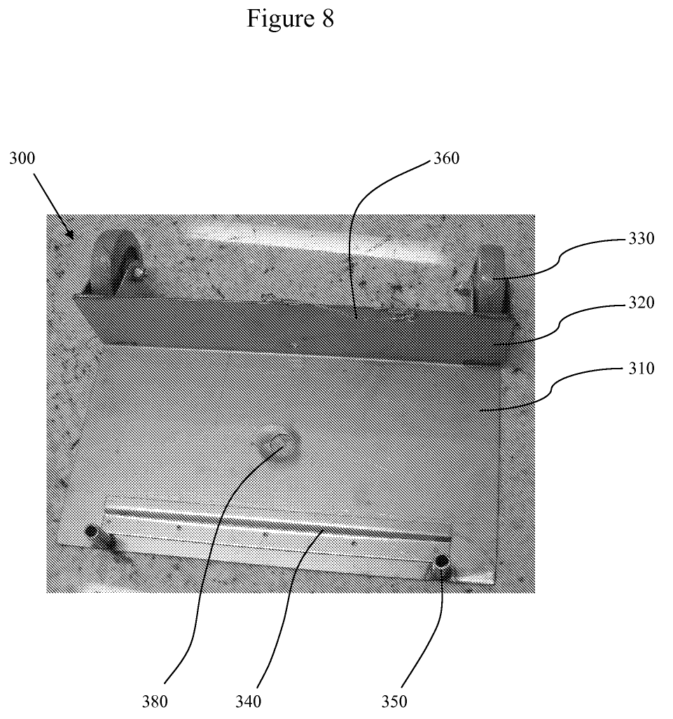

Also shown in FIG. 7, is the dolly attachment 300 stored on the bottom side of one of the plates 110a or 110b. The dolly attachment 300 may be stored in the space between the crossbeams 193 and gussets 192 of the frame 190, while the platform 100 is in a deployed orientation. The dolly attachment 300 can be stored within the platform 100 to prevent a trip hazard or to avoid loosing the dolly attachment 300, around the job site. The bottom of at least one of the plates 110a and 110b can have a cylindrical protrusion 370 extending from the plates to attach with the dolly attachment 300. The dolly attachment 300 can have a hole 380 (FIG. 8) or void to engage with the cylindrical protrusion. In order to retain the dolly attachment 300, a pin 360 (FIG. 8) may be inserted through a hole 380 in the cylindrical protrusion as shown in FIG. 7. The dolly attachment 300 may be an L-shaped metallic piece formed from a metallic alloy, such as but not limited to, aluminum, steel, iron or the like. The dolly attachment 300 can include two fixed or movable delrin bearing rubber wheels for smooth transportation of the platform 100. In other embodiments the dolly attachment 300 can use other type of bearing wheels for smooth transportation of the platform 100.

FIG. 8 is a top view of the L-shaped dolly attachment 300, according to an embodiment of the present invention. In the example embodiment, the dolly attachment 300 can be formed using a first surface 310 and a second perpendicular surface 320, both surfaces may be rigid and attached to one another at a joint. In the example embodiment shown in FIG. 8, the rigid surface 320 can be smaller than the rigid surface 310 since the first surface 310 will support the majority of the weight of the platform 100. The joint of the L-shaped dolly attachment 300 can be a welded joint or the like. In an alternate embodiment, the surfaces 310 and 320 can be formed by a single unitary body, by bending a planar metallic alloy. Attached to the second surface 320 can be a plurality of wheels 330. The wheels 330 rotate in a direction that may be generally perpendicular to the surface of the second surface 320. As stated above, in an example embodiment the two wheels 330 can be fixed delrin bearing rubber wheel that allow for smooth transportation while the platform 100 is wheeled. In an alternative embodiment other suitable fixed wheels, swivel wheel, low friction or sliding means may be used. The L-shaped dolly attachment can be coupled to the platform 100 to convert it into a functional dolly, allow on the plates to act as a surface to carry items. By converting the platform 100 into a dolly a user can easily wheel the platform 100 and allow the platform to be moved not only around the worksite, but also be carried into a vehicle for transport. The dolly feature of the platform 100 creates increased mobility, and thereby increasing the efficiency of a user.

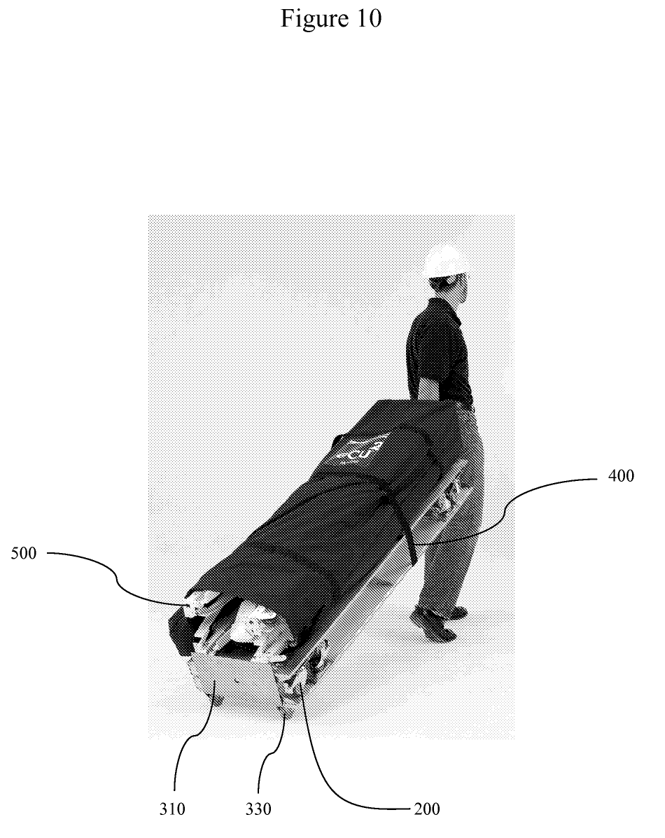

Also shown in FIG. 8, are a plurality of protrusions 350 can be formed on the periphery of the first surface 320, discussed in greater detail below with regard to FIG. 10. The protrusions 350 may be a cylindrical or rectangular shape to allow a pole to engage with the protrusions. A lip 340 can be attached to the first surface 310 such that it is configured to engage with the lip 120 of the platform 100. When the lip 340 of the dolly attachment 300 is engaged with the lip 120 of the platform 100, the dolly attachment 300 and the platform 100 can be moved together. The platform 100 is retained by the L-shaped dolly attachment 300 and can be wheeled and supported on wheels 330 of the dolly attachment 300. In an example embodiment, the lip 340 may be coupled to the first surface 310 using a plurality of rivets or the like. In an alternative embodiment, the lip 340 may be coupled to the first surface 310 by using a welding joint, screws or nails or the lip 340 and first surface 310 may be formed from a single unitary body.

A pin 360 may be attached by a chain to the second surface 320 of the dolly attachment 300. The pin 360 may be coupled to a hole and the protrusion in the bottom of the platform 100, when the platform 100 is in a deployed orientation or the dolly attachment 300 is being stored under the platform 100.

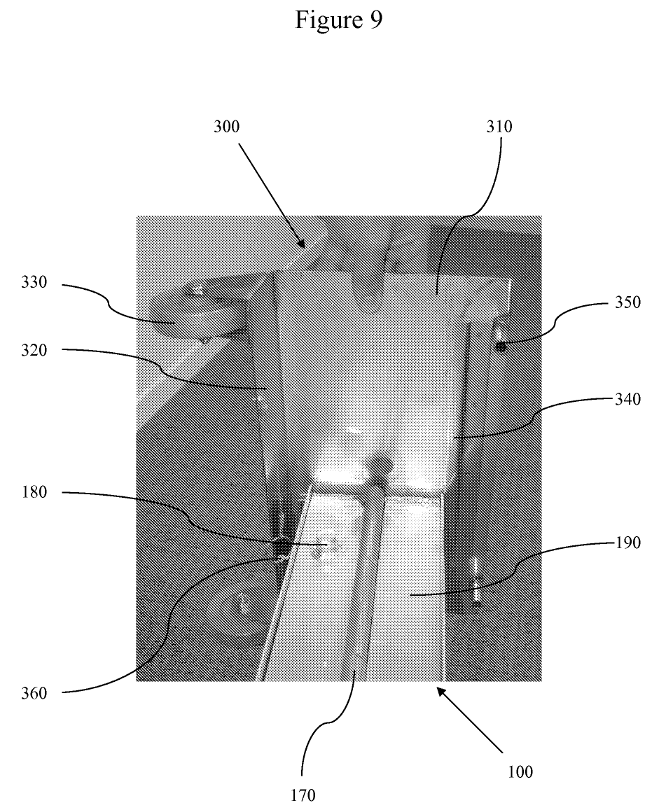

FIG. 9 is a side view of a folded platform and the L-shaped dolly attachment partially sliding onto a lip 120 of the platform 100. One of the lips 120 of the plate 110a or 110b slide between the lip 340 and the first surface 310 and to engage with the folded platform 100. As shown in FIG. 9, the joint 170 does not interfere with the dolly attachment 300. Once the dolly attachment 300 fully slides on one end of the platform 100, both the platform 100 and the dolly attachment 300 can be rotated 90 degrees and then tilted to be in an upright orientation, such that the wheels 330 may be generally perpendicular to the ground as discussed in greater detail below with regard to FIG. 10. In another embodiment, when the platform 100 and the dolly attachment 300 are tilted to be in a upright orientation the first surface 310 is intended to be flush against the ground and supporting the weight of the platform 100.

FIG. 10 is a perspective view of a person moving the mobile platform 100 and the dolly attachment 300 using wheels 330 of the dolly attachment, according to an embodiment of the present invention. The dolly attachment 300 allows the platform 100 to be converted into a dolly that can be transported using relatively little effort by one person. The platform dolly as shown in FIG. 10 can transport other items, such as but not limited to a containment unit 500 that may be placed on top of the plate 110a or 110b that is facing up while the platform 100 is in a dolly orientation. A longer attachment mechanism 400 may be used to couple the containment unit and the platform 100 to each other during transport. The attachment mechanism 400 can be similar to the Velcro straps adjusted to be long enough to surround the platform 100 and the folded containment unit. In alternative embodiments, the attachment mechanism 400 can include, but are not limited to, Velcro straps, plastic ties, ropes or the like.

FIG. 11 is a view of the support structure of a containment unit 500 being coupled to the upper surface of the mobile platform 100 as shown in FIGS. 1 and 6. The containment unit 500 may be formed of a plurality of support beams 510. In order to prevent slippage of the containment unit, the support beams 510 may be secured using Velcro straps 160. In an alternative embodiment, the lip 120 can allow the containment unit in maintaining containment and act as a barrier for items on the plates 110a and 110b.

FIG. 12 is a side view of the platform 100 with a containment unit 500 erected on top of the platform 100, according to the embodiment of the present invention, as shown in FIG. 11. An embodiment of the present invention, can include using a deployed orientation platform 100 to create a negative and/or positive pressure containment. The containment unit 500 includes a plurality of support beams and can be erected and secured onto the deployed platform 100. Inside the containment unit the platform 100 supports the weight of a ladder 600, at least one user and tools. The low height of the platform 100 enables a user to stand on top of a ladder creating an uneven weight distribution on the top surface of plates 110a and 110b, while the platform 100 maintains a stable generally horizontal orientation.

Various aspects of the multiple embodiments described above may be employed independently or in combinations thereof. The combination of some of the features of the above invention can create increased efficiencies in use, handling, transport, mobility, stability, strength and safety. For example, the use of a longitudinal axis joint allows the platform 100 to collapse or be in folded orientation. The folded orientation when combined with a dolly attachment can increase the ease of use and increase a user's productivity. Similar features can make the platform 100 easy to handle, easier to transport since the platform 100 can be wheeled, create a small footprint for storage and transporting the platform 100 in a vehicle, and allow the platform 100 to transport other objects such as a containment unit. Moreover the dolly attachment can be detached, allows the platform 100 when in a deployed orientation to not create a trip hazard, or increase safety. A trip hazard is also reduced and safety is further increased by providing storage of the dolly attachment in the deployed platform, away from the working space of the platform.

Other features such as having a low profile can create a low center of gravity by using smaller caster wheels and mounting those wheels on a thin wide mount as discussed above. The lower center of gravity of the platform makes the overall platform more stable and reduces the chances of causing injuries. Other features such as the frame 190 with gussets, hinge spacers and beams create a stable support structure for the platform 100, increasing safety and stability. The frame 190 also prevents the platform 100 from bucking. Yet other features such as the lip 120 prevent items on the platform from being pushed off the platform 100 while the platform 100 is in use.

While particular embodiments of the present invention have been shown and described, it will be obvious to those skilled in the art that the invention is not limited to the particular embodiments shown or described, and that changes and modifications may be made without departing from the spirit and scope of the claimed invention.

What is claimed is:

1. A base for supporting weight, comprising:
a plurality of rigid plates, each plate having top and bottom sides, the plates being hingedly connected to fold together along a longitudinal axis with the bottom sides of the respective plates being positioned adjacent to each other; and
a plurality of wheels positioned around the bottom periphery of each plate, the opposed wheels being positioned off center from each other when the plates are folded so that the wheels do not interfere with each other, the base when folded being adapted to be stored with the longitudinal axis in a substantially vertical direction.

2. A base as defined in claim 1, further comprising:
an L-shaped plate having at least one wheel and adapted to be at least temporarily attached to one end of the folded plates to enable the folded plates to be transported by rolling the at least one wheel along the ground.

3. A base as defined in claim 2, further comprising a support frame that is configured to secure the L-shaped plate adjacent to the bottom side of the rigid plates.

4. A base as defined in claim 2, wherein the L-shaped plate has a lip attached to the periphery of the rigid plates.

5. A base as defined in claim 1, further comprising a support frame attached to the bottom surface of the rigid plates.

6. A base as defined in claim 5, wherein the support frame has a plurality of crossbeams and gussets that are perpendicular to one another.

7. A base comprising:
a plurality of rigid planar surfaces coupled to each other using a hinge along their a axis, the rigid planar surfaces configured to deploy to form a larger horizontal surface, the larger horizontal surface having a top and a bottom side, the larger horizontal surface adapted to be in a folded orientation bringing the bottom sides of the rigid planar surfaces together;
a rigid lip extending orthogonally at the outer perimeter of the plurality of rigid planar surfaces;
a dolly attachment having an L-shaped rigid plate with two wheels adapted to be temporarily be attached to the rigid lip when the larger horizontal surface is in a folded orientation; and
the dolly attachment and the folded rigid planar surfaces forming a dolly that is capable of gliding along the floor using the two wheels.

8. The base of claim 7, wherein the axis is a longitudinal axis.

9. The base of claim 7, further comprising a plurality of offset lockable casters coupled to the bottom side of the larger horizontal surface.

10. The base of claim 9, wherein the offset lockable casters are located near the outer perimeter of the planar surfaces.

11. The base of claim 7, further comprising a support frame having a plurality of support beams coupled to the bottom side of a plurality of rigid planar surfaces.

12. The base of claim 7, the dolly attachment further comprising two cylindrical pegs extending from the rigid plate configured to support a containment unit on the dolly.

13. The base of claim 7, wherein the larger horizontal surface in a deployed orientation is configured to support the weight of at least one user, a ladder and tools.

14. The base of claim 7, wherein the dolly attachment is configured to be stored under the larger horizontal surface while the larger horizontal surface is deployed.

15. The base of claim 7, further comprising a support frame attached to the bottom surface of the rigid plates.

16. The base of claim 15, wherein the support frame has a plurality of crossbeams and gussets that are perpendicular to one another.

17. A base supporting weight, comprising:
a plurality of rigid plates, each plate having top and bottom sides, the plates being hingedly connected to fold together along a longitudinal axis;
means for folding the plates together in one direction so that the bottoms of the plates are adjacent to each other when the plates are folded together;
a plurality of wheels positioned around the bottom periphery of the plates, the wheels being positioned off center with respect to each other so that they do not interfere with each other when the plates are folded together, the wheels supporting the bottom of the plates about 3 to 6 inches above the floor in order to provide a low center of gravity for the base when the plates are unfolded.

18. The base of claim 17, further comprising means for converting the rigid plates in to a wheeled dolly.

19. The base of claim 17, further comprising means for storing a dolly attachment within the base.

20. The base of claim 17, further comprising means for coupling a containment unit to the rigid plates; and
means for transporting the rigid plates and the containment unit as a dolly.
